(19) United States
(12) Patent Application Publication
(10) Pub. No.: US 2014/0350205 A1
(43) Pub. Date: Nov. 27, 2014

(54) NOVEL SHEAR-RESISTANT POLYMER SYSTEMS, PRODUCTION THEREOF, AND ALSO USE THEREOF AS THICKENERS

(71) Applicants: Alexander Lerch, Gelnhausen (DE); Manfred Schade, Den Haag (NL); Alexander Burkhart, Essen (DE); Helmut Ritter, Wuppertal (DE)

(72) Inventors: Alexander Lerch, Gelnhausen (DE); Manfred Schade, Den Haag (NL); Alexander Burkhart, Essen (DE); Helmut Ritter, Wuppertal (DE)

(73) Assignee: Polyprec GmbH, Gelnhausen (DE)

(21) Appl. No.: 14/115,539

(22) PCT Filed: May 2, 2012
(86) PCT No.: PCT/EP2012/058029

§ 371 Date: Jan. 31, 2014

(30) Foreign Application Priority Data
May 4, 2011 (DE) 102011100430.4

(51) Int. Cl. C08F 220/58

(52) U.S. Cl. CPC C08F 220/58; C08F 2220/585; C08F 2500/19
USPC 526/287

(57) ABSTRACT

The present invention relates to thickener polymers which comprise the following structural elements 1-3:
a) as structural feature 1 at least one betainic monomer unit according to the formula below with a proportion by weight of from 0.1 to 99.9% by weight, based on the copolymer

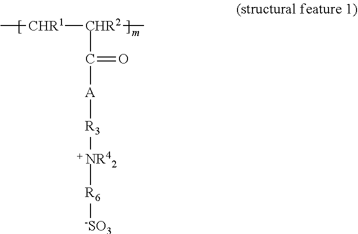

in which the mutually independent definitions are as follows:
m=integer≧1;
R¹═H, C₁₋₃ alkyl, —COOH;
R²═H, C₁₋₃ alkyl;
R³=n- or isoalkylene of the formula —(CₓH₂ₓ)—, in which x is an integer from 1 to 30;
R⁴=—H, cycloalkyl, n- or isoalkyl, aryl;
R⁵=n- or isoalkylene of the formula —(C_{y}H_{2y})—, in which y is an integer from 1 to 30;
A=—S—, —O—, —NR², in which R²═H, C₁₋₃ alkyl;
b) as structural feature 2 at least one anionically charged monomer unit according to the following formula with a proportion by weight of from 0.1 to 99.9% by weight, based on the copolymer

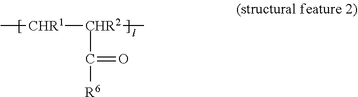

in which the mutually independent definitions are:
l=integer≧1;
R¹═H, C₁₋₃ alkyl, —COOH;
R²═H, C₁₋₃ alkyl;
R⁶=—OH, —OOH, —SH, —(CₓH₂ₓ)—COOH, —(CₓH₂ₓ)—SO₃H, —N (R²)—(CₓH₂ₓ)—SO₃H, in which —(CₓH₂ₓ)—=n- or isoalkylene and x is an integer from 1 to 30;
c) optionally as structural feature 3 one or more non-ionic comonomer units with a proportion by weight of from 0 to 50% by weight, based on the copolymer.

When compared with the prior art, the thickener polymers have increased shear resistance in aqueous formulations.

The present invention relates to the provision of novel polymers with a high level of thickening effect and use thereof in aqueous formulations, which are distinguished by increased shear resistance.

### DESCRIPTION

Polyelectrolytes, with their viscosity-increasing properties, are among the essential constituents of cosmetic and pharmaceutical preparations. The use of suitable water-soluble or water-swellable polymers is a requirement for establishing rheological properties which are appropriate to the application.

Whereas systems used previously were mainly naturally occurring systems based on polysaccharides, for example guar gum or modified celluloses (CMC, HEC, CMHEC etc.), the end of the last century saw increasing use of synthetic polymeric thickeners. Because the structure of these can be controlled chemically, they are superior in many application sectors to the natural or semi-synthetic systems with their large variations in quality. Of central importance here were high-molecular-weight crosslinked polyacrylic acids, which because of their wide application range have been, and still are, the most widely used polyelectrolyte thickeners. Patents from the 1980s, mainly from BF-Goodrich, describe the development of acrylate-only thickeners extending as far as the modern associative systems from BF-Goodrich and Rohm and Haas.

The anionic thickening systems are produced when their initially acidic monomer units are neutralized via donation of a proton to a suitable base. In an aqueous environment, the resultant salt structure permits partial spatial separation of the ion pairs. This results in electrostatic repulsion of the anionic repeat units fixed to the main polymer chain, and this leads to macroscopic “swelling” of the system in an aqueous phase.

The pKₐ value of the corresponding polymeric acid has a limiting effect on the solution properties of the polymers in water, dependent on the chemical nature of the monomer units used. When thickening systems based on (meth)acrylic acid are used, polyelectrolyte formation in aqueous solution is restricted to pH above about 5. Satisfactory thickening effects can be obtained below this pH only via neutralization of stronger acids, such as polyphosphoric acids or poly-sulphonic acids. An example that may be mentioned here is Sepigel® (polyacrylamide/polyacrylamidopropylmethylenesulphonate) from Seppic. DE10000648 A1 moreover describes anionic polymers based on AMPS and copolymers made of AMPS with neutral monomers, e.g. NVP and use of these as thickener systems.

Synthetic polymeric thickeners with their controllable properties permit the formulation of novel preparations. In addition to the very important use of covalently crosslinked polyelectrolytes as “super-absorbers” in hygiene items (e.g. nappies), there is a wide variety of other application sectors, such as dispersion stabilizers, flocculants (e.g. for wastewater purification), and as separating agents in mixtures. Other applications are found in silicate-containing systems, such as drilling slurries, or in the treatment of soils. Coatings and printing pastes or printing inks also owe their essential property profile to suitable polyelectrolyte thickeners.

The mode of action of the polymeric salts relies on electrostatic interactions with polar structures. A challenge is to control the corresponding interaction energy in order to provide varied and improved properties. Purely anionic or purely cationic polymer systems have now been used successfully for decades. However, the performance of each of the two groups of substance is subject to limits when mixtures of the two classes are used. In aqueous or organic solutions, the respective opposing charges neutralize each other, the result often being precipitation from the solution with an increase in entropy, since the respective small counterions combine and form dynamically mobile low-molecular-weight salts. This situation prevents simultaneous use of anionic and cationic structures in many interesting applications, and there are therefore many sectors in which these cannot be used. There have been many unsuccessful attempts to arrive at appropriate polyanion-polycation structures with the desired properties via chemical combination of differently charged monomers. Insuperable difficulties often arise even before polymer synthesis has been completed, and these can naturally be attributed to mutual neutralization of the different charges.

However, there are monomer structures which intrinsically incorporate both types of charge. These “polymerizable betaines” bear, within one monomer unit, both a negative charge and a positive charge, and these neutralize one another completely because they have little spatial separation. The system overall is neutral, and there is therefore no separate counterion. Polymeric betaines have been known for a long time to have specific dispersion properties, because although they have no overall charge they nevertheless have non-uniform distribution of charge density within the molecule. This property makes them capable by way of example of absorption onto any polar surface. Because there is no counterion capable of free motion, betainic structural units retain their overall neutral character even at the microscopic level. Betainic systems have hitherto been used in order to generate a viscosity-increasing salt effect in otherwise uncharged polymer systems. By way of example, Plank et al. describe, in DE 19930031, betaine-containing terpolymers and the viscosity-increasing effect of these on addition of salt. Schulz et al. describe, in U.S. Pat. No. 5,153,289, a combination of SPE with NVP and a marked increase in viscosity on addition of salt, whereas copolymers of AMPS and NVP exhibit an inverse effect. In U.S. Pat. No. 5,311,223, Vanderlaan et al. describe another important betaine application as comonomer for production of contact lenses, where an improved water-retention capability is ascribed to the SPE. All previous publications describe the use of the betaines with uncharged monomer units.

Surprisingly, it has now been found that betaines, e.g. SPE, can easily be copolymerized with anionic AMPS. The combination of the copolymers with water gives novel gels with surprising rheological properties. By way of example, gels based on AMPS/SPE copolymers exhibit a significant improvement in shear resistance when compared with gels based on commercially available AMPS/NVP copolymers, e.g. Aristoflex AVC (Clariant). Shear resistance is an important criterion for the production and use of the said products. By way of example, gels can be produced at higher speed because higher-intensity stirring can be used. Shear resistance is also important in the use as viscosity-modifying polymer in liquid drilling fluids.

Copolymer structures considered to be within the invention comply with the following criteria (1) to (3):

(1) An essential component present in all copolymers according to the invention is one or more betainic monomer units of the structural unit (1). The proportion by weight of the structural unit (1) is from 0.1 to 99.9% by weight, based on the copolymer

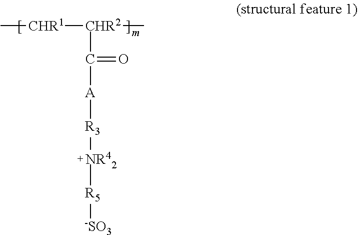

The mutually independent definitions in this formula are:
m=integer≧1;
R¹═H, C₁₋₃ alkyl, —COOH;
R²═H, C₁₋₃ alkyl;
R³=n- or isoalkylene of the formula —(CₓH₂ₓ)—, in which x is an integer from 1 to 30;
R⁴=—H, cycloalkyl, preferably comprising from 3 to 7 carbon atoms, n- or isoalkyl, preferably comprising from 1 to 12 carbon atoms, aryl, preferably comprising from 5 to 18 carbon atoms,
R⁵=n- or isoalkylene of the formula —(C_{y}H_{2y})—, in which y is an integer from 1 to 30;
A=—S—, —O—, —NR²—, in which R²═H, C₁₋₃ alkyl.

(2) A second essential structural feature that must moreover be present is one or more anionically charged monomer units with a proportion by weight of from 0.1 to 99.9% by weight, based on the copolymer.

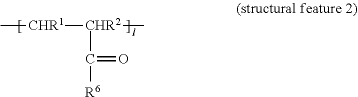

The mutually independent definitions in this formula are:
l=integer≧1;
R¹═H, C₁₋₃ alkyl, —COOH;
R²═H, C₁₋₃ alkyl;
R⁶=—OH, —OOH, —SH, —(CₓH₂ₓ)—COOH, —(CₓH₂ₓ)—SO₃H, —N(R²)—(CₓH₂ₓ)—SO₃H, in which —(CₓH₂ₓ)—=n- or isoalkylene and x is an integer from 1 to 30.

(3) It is also optionally possible to use one or more non-ionic comonomers. These are formed by the comonomer units of the structural feature 3 of the copolymers according to the invention. The proportion by weight of the non-ionic comonomer units here is from 0 to 50% by weight, based on the copolymer. It is possible to use both mono- and di- or polyvinylic comonomers. Di- or polyvinylic comonomers here lead to crosslinking of the structures. The molar mass of the comonomers is preferably <300 g/mol.

The copolymers described in this invention are preferably produced by using the precipitation polymerization method, particularly preferably in a tertiary alcohol.

A more detailed description of the invention is provided below. Parent polymer structures considered to be within the invention in the present specification are those which include the structural feature (1). Monomers of these internal salts (also termed betaines) were introduced to the market by Raschig (Luwigshafen) and are suitable without further pretreatment for use in the polymerization reaction. A non-limiting list of suitable monomers is given below, where these can be used for the free-radical polymerization reaction and form the structural feature (1) of the copolymers according to the invention. In principle, it is possible to use any of the sulphobetaines which are accessible to a free-radical polymerization reaction. It is preferable to use N,N-dimethyl-N-(2-methacryloyloxyethyl)-N-(3-sulphopropyl)ammonium betaine (SPE), N,N-dimethyl-N-(3-methacrylamidopropyl)-N-(3-sulphopropyl)ammonium betaine (SPP) and 1-(3-sulphopropyl)-2-vinyl pyridinium betaines (SPV). Mixtures of betainic species are likewise within the invention. The proportion by weight of the structural feature (1) is from 0.1 to 99.9%, preferably from 0.1 to 50%, and particularly preferably from 3 to 25% by weight, of the copolymers according to the invention.

The main polymeric structure must have, alongside the structural feature (1), a further feature (2) which derives from the group of the anionic vinyl compounds capable of free-radical polymerization. For the purposes of the invention, anionic monomers are any of the acidic monomers which give a pH<7 in an aqueous—or organic aqueous—environment. Among the said group are therefore all monomers that derive from weak or strong mineral acids, such as carboxylic, phosphonic, phosphoric and sulphonic acid, having one or more labile (acidic) protons. The monomers according to the invention can be used in free form or in the form of their organic or inorganic salts (or else partial salts in the case of polybasic acids). The invention likewise includes mixtures of two or more members of the said substance group. Anionic members of the vinylic sulphonic acids group have been identified as particularly suitable because they have particularly high acidity. The following monomers may be mentioned as examples for illustration of the structural feature (2). (3-Sulphopropyl)acrylate, potassium salt (SPA); (3-sulphopropyl)methacrylate, potassium salt (SPM), both obtainable from Raschig GmbH, Ludwigshafen; 2-acrylamidopropylmethylenesulphonic acid (AMPS from Lubrizol) and salts of AMPS, namely alkali metal salts and ammonium salts and the Na salt of vinylsulphonic acid. Mixtures and/or mixed salts of the said monomer group are likewise suitable. The proportion by weight of the structural feature (2) is from 0.1 to 99.9% by weight, preferably from 20 to 98% by weight, particularly preferably from 50 to 80% by weight.

The structural feature (3) encompasses all of the non-ionic comonomer units which are formed from comonomers capable of free-radical polymerization and which have one or more vinylic functionalities. The use of monomers having vinylic functionalization≧2 can lead to crosslinking or branching of the resultant polymer structures. Examples of monofunctionalized monomers are (meth)acrylamide and N-alkylation derivatives of these (e.g.: diisopropylacrylamide, ethylhexylacrylamide and/or dimethylacrylamide), esters of (meth)acrylic acid (e.g.: hydroxyethyl methacrylate, hydroxypropyl methacrylate, ethyl(meth)acrylate, propyl acrylate, butyl acrylate, stearyl acrylate, lauryl methacrylate), styrene, α-methylstyrene, 2-vinylpyridine and its quaternization products, 4-vinylpyridine and its quaternization products and polymerizable esters of crotonic or itaconic acid. Alongside this selection of monofunctionalized monomers, another possibility, as just mentioned, is the use of polyfunctionalized monomers for the purposes of the invention, where these lead to crosslinking and/or branching of the polymer chains. Examples here are methylenebisacrylamide, glycol-based diacrylates and, respectively, dimethacrylates (e.g.: diethylene glycol dimethacrylate or 1,3-glycerol dimethacrylate), and triacrylates or trimethacrylates (trimethylolpropane trimethacrylate, trimethylolpropane triacrylate, glycerol 1,2,3-trimethacrylate, glycerol 1,2,3-triacrylate), where the latter group of crosslinking compounds is preferred. The proportion by weight of the structural feature (3) is from 0 to 50% by weight, preferably from 0.1 to 50% by weight and particularly preferably from 0.2 to 25% by weight, based on the copolymer.

Particularly preferred combinations of the structural features 1-3 in the copolymers according to the invention are the following:

(3-sulphopropyl)acrylate potassium salt (SPA) (structural feature 2), N,N-dimethyl-N-(2-methacryloyloxyethyl)-N-(3-sulphopropyl)ammonium betaine (SPE) (structural feature 1), and trimethylolpropane trimethacrylate (structural feature 3);

N,N-dimethyl-N-(3-methacrylamidopropyl)-N-(3-sulphopropyl)ammonium betaine (SPP) (structural feature 1), (3-sulphopropyl)methacrylate potassium salt (SPM) (structural feature 2), and trimethylolpropane triacrylate (structural feature 3);

N,N-dimethyl-N-(3-methacrylamidopropyl)-N-(3-sulphopropyl)ammonium betaine (SPP) (structural feature 1), (3-sulphopropyl)acrylate potassium salt (SPA) and (3-sulphopropyl)methacrylate potassium salt (SPM) (structural feature 2), and trimethylolpropane triacrylate (structural feature 3);

N,N-dimethyl-N-(3-methacrylamidopropyl)-N-(3-sulphopropyl)ammonium betaine (SPP) (structural feature 1), 2-acrylamido-2-propylmethylenesulphonic acid, ammonium salt (structural feature 2), and

trimethylolpropane trimethacrylate;

N,N-dimethyl-N-(2-methacryloyloxyethyl)-N-(3-sulphopropyl)ammonium betaine (SPE) (structural feature 1), 2-acrylamido-2-propylmethylenesulphonic acid, ammonium salt (structural feature 2), and trimethylolpropane trimethacrylate (structural feature 3);

N,N-dimethyl-N-(2-methacryloyloxyethyl)-N-(3-sulphopropyl)ammonium betaine (SPE) (structural feature 1), 2-acrylamido-2-propylmethylenesulphonic acid, ammonium salt (structural feature 2), and

trimethylolpropane trimethacrylate and hydroxyethyl methacrylate (HEMA) (structural feature 3);

N,N-dimethyl-N-(2-methacryloyloxyethyl)-N-(3-sulphopropyl)ammonium betaine (SPE) (structural feature 1), (3-sulphopropyl)methacrylate potassium salt (SPM) (structural feature 2), and stearyl acrylate (structural feature 3);

1-(3-sulphopropyl)-2-vinylpyridinium betaine (SPV) (structural feature 1), 2-acrylamido-2-propylmethylsulphonic acid, sodium salt (structural feature 2), and methylenebisacrylamide, and also hydroxyethyl methacrylate (HEMA) (structural feature 3).

All of the polymers mentioned in this invention were produced by the precipitation process. Main features of the said process are firstly a precondition that the monomers are at least sparingly soluble in the solvent used and secondly that when the resultant polymers exceed a system-specific average molecular weight they are almost completely insoluble or merely swellable in the respective solvent or solvent mixture. A more detailed description of the process is provided in the examples. To achieve high average molecular weights, it is necessary to use solvents which are very substantially inert with respect to the actual polymerization reaction. Examples of such media are tertiary alcohols, in particular tert-butanol, which has proven particularly suitable from a technical point of view because of its moderate boiling point. Solvent mixtures (e.g.: tert-butanol/water) are likewise within the invention.

The free-radical reaction can be initiated by using not only initiator substances, e.g. azoisobutyronitrile, dilauroyl peroxide, benzoyl peroxide, hydrogen peroxide, potassium peroxodisulphate, and sodium peroxodisulphate, but also by using electromagnetic radiation (in particular UV radiation), or thermal initiator systems. Aliphatic peroxo initiators are exceptionally important from a toxicological point of view. Dilauroyl peroxide is particularly suitable and widely accepted.

The hydrodynamic volume in the case of linear, crosslinked or branched macromolecules can be determined via dynamic light scattering. Since macromolecules in solution are rarely spherical, but instead mostly form convolute structures or ellipsoids, the hydrodynamic volume is based on the volume of a sphere having equivalent frictional properties.

Individual polymer particles of size from 1 nm to 10 mm in the dried state are within the invention, preference being given to the range from 10 nm to 1 mm, and particular preference being given to the range from 50 nm to 50 μm. Formation of physical aggregates composed of a plurality of the said particles does not impair the properties of the products according to the invention. No preferred molecular-weight range is usually stated for crosslinked polymers, since by definition crosslinked systems are regarded as having almost infinite molecular weight, and it therefore makes no sense to give preference to any partial range. Crosslinked polyelectrolyte systems, such as carbomers based on carboxylic acid, are excellent thickeners in pure water and are used as “rheological modifiers” in many application sectors. However, the shear resistance of the gels varies markedly. The following test method was developed for measurement of shear resistance.

Each of the synthetic gel-formers is swollen with water to give a 1% by weight solution, these materials being mixed for 4 h with a stirrer having a precision glass gland until a clear homogeneous solution has been produced. The resultant hydrogels are characterized by means of rheological tests.

The viscosity measurements were made with a shear-stress-controlled test system from Thermo Scientific (Haake Mars rheometer). Plate-on-plate test geometry was selected (plate PP35 Ti/Meas plate MP35 18/8, cone diameter 35 mm). The separation of the plates between which the sample material was applied was always 0.5 mm. The gels were introduced between the plates and tested at shear rates of from 0.001 s⁻¹ to 1000 s⁻¹. The samples were subjected to six successive tests, with pauses respectively of 5 seconds, one hour, two hours, three hours, four hours and five hours between the individual tests to allow relaxation of the sample material. The sample temperature here was maintained at constant 25° C. The pH of the solutions was adjusted to 5 by using small amounts of lactic acid if necessary.

Comparison of the viscosities prior to and after shear was used to determine the viscosity-reduction index. The impressive effect of the betaine on shear resistance is shown in the table below.

TABLE 1
Viscosities measured at shear rate 100 s⁻¹

| | 5 sec. | 1 h | 2 h | 3 h | 4 h | 5 h |
|---|---|---|---|---|---|---|
| Polymer according to | 3.7 | 3.05 | 2.37 | 1.77 | 1.23 | 0.77 |
| example (1) | | | | | | |
| Polymer according to | 3.0 | 2.85 | 2.03 | 1.61 | 1.12 | 0.73 |
| example (2) | | | | | | |
| Polymer according to | 3.60 | 3.03 | 2.33 | 1.70 | 1.21 | 0.76 |
| example (3) | | | | | | |
| Aristoflex AVC) | 2.59 | 2.07 | 1.68 | 1.33 | 1.01 | 0.70 |

Commentary: Examples 1, 2 and 3 according to the invention clearly show improved shear resistance in comparison with the commercially available product Aristoflex AVC.

Details of further synthesis examples for illustration of the invention are given below. Instructions for the practical conduct of the polymerization reactions are found in “Praktikum der Makromolekularen Stoffe” [Practical aspects of macromolecular materials] by H. Cherdron et al., Wiley VCH (1999):

### PRODUCTION EXAMPLES

### Example (1)

### According to the Invention

245 g of tert-butanol and 6.25 g of water are used as initial charge in a 0.5 1 or 1.0 1 multinecked flask equipped with stirrer with ground glass gland, reflux condenser, pH meter and inlet for NH₃ or N₂. 31.60 g of 2-acrylamido-2-methylpropanesulphonic acid (finely ground in a mortar) are then introduced and dispersed. Ammonia is then introduced within a period of 30 min until the resultant pH is from 6 to 7 (monitoring by way of pH meter). The dispersion originally present disappears here and all that remains is slight haze. The mixture is then stirred for a further 30 min. The pH meter is replaced by a thermometer. 15 g of SPE and 0.94 g of crosslinking agent (TMPTA) are then added to the cloudy solution in nitrogen-countercurrent mode. The reaction mixture is heated to 60° C. and the appropriate amount of dilauroyl peroxide catalyst is metered into a mixture. As soon as a white precipitate forms and the temperature rises, indicating the start of the reaction, the stirrer speed is reduced from 300 rpm to 100 rpm. After a further 15 min, the nitrogen stream is stopped. The total stirring time at 60° C. after initiator addition is 60 min. The mixture is then heated to reflux and stirred for a further 2 h before the reaction solution is cooled to room temperature. The solvent is removed under reduced pressure, 130 mbar and at a bath temperature of 40° C., and then the mixture is dried at 70° C. The white residue remaining is dried for 24 h in a high-vacuum oven at 70° C.

### Example (2)

### According to the Invention

Procedure Similar to That of Example (1)
Monomer usage: Structural feature (1) 1.80 g of N-(3-sulphopropyl)-N-methacryloxyethyl-N,N-dimethylammonium betaine (SPE)
   Structural feature (2) 15.80 g of 2-acrylamido-2-methylpropanesulphonic acid (AMPS)
   Structural feature (3) 0.36 g of trimethylolpropane triacrylate (TMPTA)

### Example (3)

### According to the Invention

Procedure Similar to that of Example (1)
Monomer usage: 31.60 g (0.15 mol) of 2-acrylamido-2-methylpropanesulphonic acid (AMPS)
   13.92 g (0.05 mol) of N-(3-sulphopropyl)-N-methacrylamidoethyl-N,N-dimethylammonium betaine
   0.91 g (0.003 mol) of trimethylolpropane triacrylate (TMPTA)

Examples of use:

Obvious applications of the interesting property profile of the polymers according to the invention are in the cosmetics sector and also in pharmacy. The trend towards aqueous formulations and away from heavy oil-based cream requires development of novel thickener systems which comply with the requirements of modern formulations, the list of constituents of which sometimes encompasses more than 30 components. The exceptional shear resistance of the polymer gels described in this invention has been emphasized above. This profile makes them suitable for a very wide variety of applications, in cosmetics, in pharmacy and in other applications where there is a requirement to adjust the viscosity of aqueous formulations.

Acidic Cream:

| | | |
|---|---|---|
| Phase A | Methyl glucose sesquistearate | 2% |
| | Stearyl alcohol | 2% |
| | Cyclomethicone | 10.5% |
| | Isoparaffin | 7.2% |
| | Capryloyl salicylic acid | 1.4% |
| | Octyldodecanol | 5% |
| | Perfume | 0.3% |
| Phase B | Water | q.s. 100% |
| | Sea salt | 0.10% |
| | Preservatives | 0.5% |
| | Glycerol | 5% |
| Phase C | Polymer according to Example 1 | 2% |

Production: C is incorporated by stirring into phase B and then phase A is stirred into the mixture. The product is then homogenized

The use of the polymers described has proven to be particularly suitable in the production of transparent, clear gels.

Clear Gel:

| | | |
|---|---|---|
| Phase A | Ethanol | 20% |
| | Glycerol | 6% |
| | Perfume | 0.30% |
| Phase B | Preservatives | 0.5% |
| | Polymer according to Example 3 | 1.0% |
| | Water | q.s. 100% |

Production: A is incorporated into phase B by stirring and the product is homogenized

Moisturizing Cream

| | | |
|---|---|---|
| Phase A | Glycerol | 12% |
| | Isopropyl palmitate | 4.0% |
| | Glyceryl stearate | 5.0% |
| | Aloe vera | 0.5% |
| | Jojoba oil | 2.0% |
| | Perfume | 0.25% |
| Phase B | Preservatives | 0.5% |
| | Polymer according to Example 2 | 2.0% |
| | Water | q.s. 100% |

Production: A is incorporated by stirring into B and the product is homogenized.

Production of an ultrasound gel used as an example of a pharmaceutical application.

Ultrasound Gel

| | |
|---|---|
| Glycerol | 15% |
| Polymer according to Example 1 | 1.5% |
| Water | q.s. 100% |

The following formulations are used as examples for the detergents and cleaning compositions sector:

Acidic Cleaner

| | |
|---|---|
| Marlon PS 65 (Sasol) | 7% |
| Lauryl ethoxylate 7 | 2.5% |
| Citric acid | 14% |
| NaCl | 0.25% |
| Polymer according to Example 1 | 1.2% |
| Water | q.s. 100% |

Liquid Toilet Gel

| | |
|---|---|
| Lauryl sulphate | 2.5% |
| Oleyl ethoxylate 7 | 5% |
| Hydrogen peroxide | 5% |
| Citrate/citric acid | 8% |
| Polymer according to Example 2 | 1.3% |
| Water | q.s. 100% |

The polymers according to the invention can also be used to improve construction materials mixtures. Here, the setting time of the mortar mixture is lengthened so as to give, for example, more adjustment time during tile laying:

The tile adhesive is produced from:

| | |
|---|---|
| PZ 45 Portland cement | 30% |
| Quartz sand (<0.5 mm) | 45% |
| Tylose MH 200 YP2 (commercially | 4.0% |
| available product from Shin-Etsu) | |
| Polymer according to Example 1 | 0.2% |
| Water | q.s. 100% |

There are also possible applications in silicate- or clay-containing systems, e.g. as setting retarders in cement, in the production of petroleum, in particular in the form of drilling fluid, or for the treatment of contaminated soils. Thickeners for printing pastes and printing inks, coatings or coating compositions are generally often adversely affected by shear stress and it would thus be possible to improve these.

1. Copolymers comprising
a) as structural feature 1 at least one betainic monomer unit according to the formula below with a proportion by weight of from 0.1 to 99.9% by weight, based on the copolymer 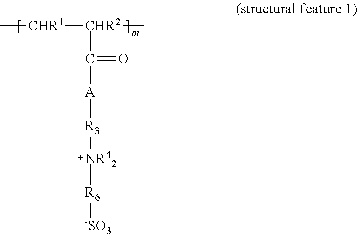
in which the mutually independent definitions are as follows:
m=integer≧1;
R¹═H, C₁₋₃ alkyl, —COOH;
R²═H, C₁₋₃ alkyl;
R³=n- or isoalkylene of the formula —(CₓH₂ₓ)—, in which x is an integer from 1 to 30;
R⁴=—H, cycloalkyl, n- or isoalkyl, aryl;
R⁵=n- or isoalkylene of the formula —(C_{y}H_{2y})—, in which y is an integer from 1 to 30;
A=—S—, —O—, —NR², in which R²═H, C₁₋₃ alkyl;
b) as structural feature 2 at least one anionically charged monomer unit according to the following formula with a proportion by weight of from 0.1 to 99.9% by weight, based on the copolymer 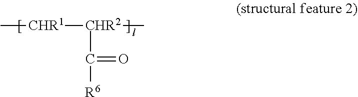
in which the mutually independent definitions are:
l=integer≧1;
R¹═H, C₁₋₃ alkyl, —COOH;
R²═H, C₁₋₃ alkyl;
R⁶=—OH, —OOH, —SH, —(CₓH₂ₓ)—COOH, —(CₓH₂ₓ)—SO₃H, —N(R²)—(CₓH₂ₓ)—SO₃H, in which —(CₓH₂ₓ)—=n- or isoalkylene and x is an integer from 1 to 30;
c) optionally as structural feature 3 one or more non-ionic comonomer units with a proportion by weight of from 0 to 50% by weight, based on the copolymer.

2. Copolymers according to claim 1, comprising from 0.1 to 50% by weight of the structural feature 1, from 20 to 98% by weight of the structural feature 2 and from 0.1 to 50% by weight of the structural feature 3, based in each case on the copolymer.

3. Copolymers according to claim 1, comprising from 3 to 25% by weight of the structural feature 1, from 50 to 80% by weight of the structural feature 2 and from 0.2 to 25% by weight of the structural feature 3, based in each case on the copolymer.

4. Copolymers according to claim 1, comprising a crosslinked structure is obtainable via use of one or more non-ionic comonomers having at least two vinylic groups which have polymerization activity, where these form the structural feature 3.

5. Use of copolymers according to claim 1 in cosmetic or pharmaceutical preparations or as viscosity-modifying copolymer in liquid drilling fluids.

6. Use of copolymers according to claim 1 as thickeners.

7. Use of copolymers according to claim 1 as thickeners of electrolyte-containing solutions with electrolyte content greater than 0.1% by weight, based on the entire formulation.

8. Use of copolymers according to claim 1 in aqueous formulations with pH<6.0.

9. Use of copolymers according to claim 1 in detergents and cleaning compositions.

10. Use of copolymers according to claim 1 as thickeners for systems with from 20-99% by weight content of water-miscible organic solvents.

11. Process which can produce copolymers as defined in claim 1 and which encompasses precipitation polymerization in a tertiary alcohol.

12. Copolymers according to claim 2, comprising a crosslinked structure is obtainable via use of one or more non-ionic comonomers having at least two vinylic groups which have polymerization activity, where these form the structural feature 3.

13. Copolymers according to claim 3, comprising a crosslinked structure is obtainable via use of one or more non-ionic comonomers having at least two vinylic groups which have polymerization activity, where these form the structural feature 3.

14. Copolymers according to claim 5, comprising from 0.1 to 50% by weight of the structural feature 1, from 20 to 98% by weight of the structural feature 2 and from 0.1 to 50% by weight of the structural feature 3, based in each case on the copolymer.

15. Copolymers according to claim 6, comprising from 0.1 to 50% by weight of the structural feature 1, from 20 to 98% by weight of the structural feature 2 and from 0.1 to 50% by weight of the structural feature 3, based in each case on the copolymer.

16. Copolymers according to claim 7, comprising from 0.1 to 50% by weight of the structural feature 1, from 20 to 98% by weight of the structural feature 2 and from 0.1 to 50% by weight of the structural feature 3, based in each case on the copolymer.

17. Copolymers according to claim 8, comprising from 0.1 to 50% by weight of the structural feature 1, from 20 to 98% by weight of the structural feature 2 and from 0.1 to 50% by weight of the structural feature 3, based in each case on the copolymer.

18. Copolymers according to claim 9, comprising from 0.1 to 50% by weight of the structural feature 1, from 20 to 98% by weight of the structural feature 2 and from 0.1 to 50% by weight of the structural feature 3, based in each case on the copolymer.

19. Copolymers according to claim 10, comprising from 0.1 to 50% by weight of the structural feature 1, from 20 to 98% by weight of the structural feature 2 and from 0.1 to 50% by weight of the structural feature 3, based in each case on the copolymer.

20. Copolymers according to claim 11, comprising from 0.1 to 50% by weight of the structural feature 1, from 20 to 98% by weight of the structural feature 2 and from 0.1 to 50% by weight of the structural feature 3, based in each case on the copolymer.
